(19) United States
(12) Patent Application Publication
(10) Pub. No.: US 2024/0411622 A1
(43) Pub. Date: Dec. 12, 2024

(54) DATA PROCESSING METHOD AND SYSTEM FOR IMPROVED BUSINESS PROCESS MONITORING

(71) Applicant: Coliance Limited, London (GB)

(72) Inventor: John Hawkins, Southampton (GB)

(21) Appl. No.: 18/661,589

(22) Filed: May 11, 2024

(30) Foreign Application Priority Data
Jun. 7, 2023 (GB) 2308499.9

(51) Int. Cl. G06F 9/54; G06Q 10/087

(52) U.S. Cl. CPC G06F 9/542; G06Q 10/087; G06F 2209/545

(57) ABSTRACT

A method of monitoring a data processing system which is processing a transaction, comprising steps of: receiving event data from each of a plurality of data processing sub-systems making up the data processing system, the event data corresponding to events taking place within the plurality of data processing sub-systems as the data processing system processes the transaction; deriving address information from the event data; mapping the address information to corresponding process status indicator labels; and displaying the process status indicator labels for review by a user.

### FIELD OF THE DESCRIPTION

The present disclosure is directed to the technical field of data processing, and more particularly to a data processing method and system for improved business process monitoring.

### BACKGROUND

A business process, such as a purchase order/invoice transaction processing method, is typically carried out by a data processing system which includes a plurality of different data processing platforms, each performing a specific task in the overall business process. For example, a purchase order/invoicing business method is typically carried out by a data processing system having an Application Programming Interface (API) Manager data processing platform, an Enterprise Service Bus (ESB) data processing platform, and a system of record (SOR) platform, such as a database management platform or a Customer Relationship Management (CRM) platform.

The API Manager platform typically carries out the task of managing the various Application Programming Interfaces (APIs) in an enterprise, including designing, documenting, deploying and overseeing the APIs, as well as acting as a mediator or single point of entry, translating messages between different services.

The ESB platform is a centralised middleware platform that is used to integrate various enterprise systems and applications, replacing the need for point-to-point communication, which is highly complex and not easily scalable. When one platform or system has a message to pass on to another, the ESB data processing platform translates the message and routes it to the correct location.

Lastly, the system of record platform stores data into a database as well as potentially performing customer relationship management (CRM) functionality on the stored data.

A business user of such a data processing system is very interested in monitoring the business progress of the transaction, and in particular, needs to be kept informed of which stage of progress the transaction has achieved. For example, in the purchase order/invoice transaction processing method, the organisation deploying the data processing system would be the organisation receiving purchase orders from its customers, processing the purchase orders, shipping the relevant products to the customers, and sending an invoice to the customer. A business user in the organisation needs to be able to immediately answer questions from customers such as whether the customer's purchase order has been received, whether the receipt of the purchase order has been acknowledged, and whether the relevant goods that the customer is seeking to purchase have been shipped to the customer by the organisation.

This information should be obtainable immediately, without significant delay. However, this has typically been difficult to achieve because each of the different data processing platforms making up the entire data processing system are structured differently from a technical standpoint, have been developed separately from each other, often using their own proprietary data formats, and are often coming from different vendors.

It would be useful to be able to overcome the technical challenges mentioned above and provide a business process monitoring tool, capable of integrating data from various ones of the plurality of data processing platforms (or sub-systems) making up the overall data processing system, and providing current, up to date business process progress reports to business users.

### SUMMARY

The present disclosure provides a method of monitoring a data processing system which is processing a transaction, comprising steps of:
(a) receiving event data from each of a plurality of data processing sub-systems making up the data processing system, the event data corresponding to events taking place within the plurality of data processing sub-systems as the data processing system processes the transaction, the event data having a data structure format unique to the specific data processing sub-system from which the event data was received;
(b) deriving address information from the received event data, wherein the address information corresponds to a logical location in a corresponding sub-system where data related to a corresponding event can be perceived as having been either processed by, stored in or, having held a state in;
(c) mapping the address information to corresponding process status indicator labels; and
(d) displaying the process status indicator labels for review by a user.

Also provided is a system for carrying out the method, and a computer readable medium storing a program for, when executed on a computer system, causing the computer system to carry out the method.

Event address data from a plurality of data processing platforms included in the overall data processing system is mapped to specific business process status indicators. Accordingly, when the event address data is received by the business process monitoring tool from each of the plurality of data processing platforms, the relevant business process transaction indicators (stage of the business process) can be determined from the event address data for presentation to the user, even though the technical data format of the data, such as the address format data, is typically different for each of the data processing platforms.

Accordingly, using the technical advances described herein, the technical challenges mentioned above have been overcome and the advances described herein provide a business process monitoring tool, capable of integrating data from various ones of the plurality of data processing platforms (or sub-systems) making up the overall data processing system, and providing current, up to date business process progress reports to business users. This requires that data is collected from each of these disparate systems in a common format which can then be analyzed to understand, for example, a) which of the plurality of systems the data came from and b) which business process the data is referring to.

### BRIEF DESCRIPTION OF THE DRAWINGS

FIG. 1 is a block diagram showing an example implementation of a data processing system according to an exemplary implementation of the present disclosure;

FIG. 2 is a block diagram showing how underlying system events change the state of a business process and thus how the events can be translated into business events, according to exemplary implementations of the present disclosure.

FIG. 3 shows an example of a GUI screen that a business user can see, with only the stages of the business process shown, according to a sample implementation;

FIG. 4 is a blow-up version of a portion of the GUI screen of FIG. 3;

FIG. 5 shows an example of a GUI screen that an operations team user can see, according to a sample implementation;

FIG. 6 is a blow-up version of a portion of the GUI screen of FIG. 5;

FIG. 7 is a block diagram showing an example implementation of a business process monitoring tool, for monitoring a data processing system, according to the present disclosure; and

FIG. 8 is a block diagram showing the logic events being received and creating and changing a business process instance;

FIG. 9 is a block diagram showing the logic events being received from one address that could be destined for one of two or more business processes; and

FIG. 10 is a flow chart showing functional steps carried out according to a method in accordance with an example of the disclosed technology.

### DETAILED DESCRIPTION OF EXAMPLE IMPLEMENTATIONS

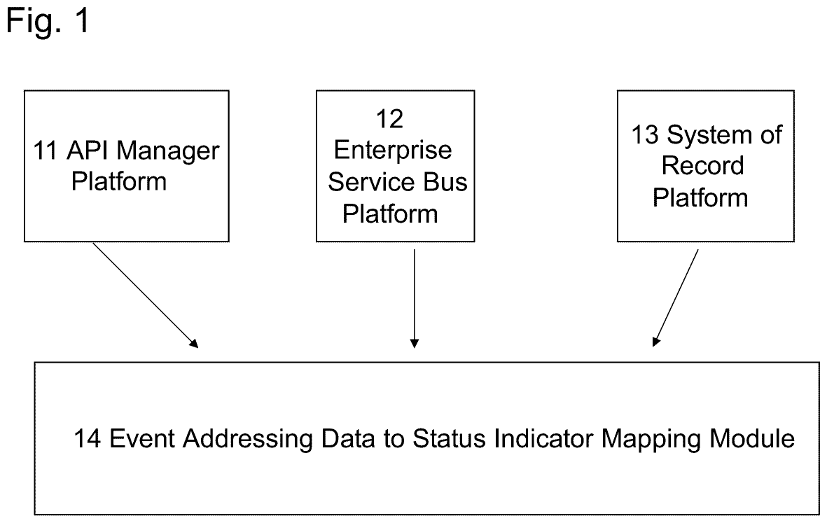

FIG. 1 is a block diagram showing an example implementation of a data processing system according to the present disclosure. As shown in FIG. 1, a data processing system is deployed by an enterprise (such as the enterprise which serves customers, as explained above, receiving purchase orders from such customers, fulfilling the orders, shipping goods to the customers and sending invoices to the customers).

The data processing system includes, in this illustrative example, the three data processing platforms mentioned above: the API Management Platform 11, the ESB Platform 12 and the System of Record Platform 13. Other examples of such data processing platforms which inter-operate within an enterprise to implement an overall data processing system could include an order management platform, a transport management platform, or a warehouse management platform.

As part of each of the platforms (11, 12, 13) performing their respective functions/tasks (as was described above), each of these platforms (11, 12, 13) generates, or can be made to generate, data processing events, specific to the particular platform. That is, as the particular platform performs its data processing task, events can be generated as artefacts of the processing. Also, a platform (11, 12, 13) can be polled and an event can be generated or raised based on the polling. For example, the event could be tracking a document passing through the system, e.g., a message on a queue or a message passing through an ESB in-memory. Still further, a platform (11, 12, 13) can have an option where the generation of events can be enabled (or turned on). A monitoring tool can also be used by the operations team to configure the specific data that is to be seen or produced during the running of the platform (11, 12, 13).

Generally, these events have data structure formats, including addressing information, which is unique to the particular platform. Addressing information for events of one platform may have different addressing attributes and formats, as compared to addressing information for events of another platform. Accordingly, the addressing information is based on attributes that can be derived from, or found within, the system events. An event can include a large amount of attribute data but only some of the attribute data is typically useful as addressing information for the event.

Addressing (and addressing information) can be considered as the idea that within every system there is a logical location in the system that the message can be perceived as having been either processed by or stored in or, in the case of a System of Record, having held a state in.

So, for instance, in the case of a message queueing system, the message will have been temporarily stored on and then, as it moves, passed through, a queue which resides on a queue manager-both queues and queueing system are logical constructs of a messaging system and not the actual machine where the queue manager or queue reside.

Therefore, it can be stated that if a notification is received from the system that a message is on a queue then the location could be stated in terms of the queue and the queue manager:

```
{
  (a) “QueueManager”; “MY.QM”,
  (b) “Queue”: “My.Q”
}
```

Some systems can also state more accuracy in that event-they can determine that the message has just been, for instance, put to, or, consumed from, that queue. Therefore, it can be added to the addressing information the concept of “put” and “Get”

```
{
  (a) “QueueManager”; “MY.QM”,
  (b) “Queue”: “My.Q”
  (c) “Action”:”Get”
}
```

The act of Getting the message from the queue completes the transition of the state from A->B e.g. “received” to “processed” perhaps. i.e. the state transition is tied to the receipt of an event of a specific address location.

A different example is where a series of database tables are updated in a specific order such that a specific set of data events can be seen as a transition from one state to another. For instance, if the table “ORDERS” has a column “sent date” then the “address” of the event can be deemed to be

```
{
  (a) “Database”: “OrderDB”
  (b) “Table”: “Orders”
  (c) “sent_date”: “10-02-2023:10.04.02”
}
```

In this case the address contains the Database name, the location “Table” and the column of “sent date” which is notnull. Thereby indicating that the order has been sent and that the order could e.g. change state from e.g. “Placed->Sent”.

If the system were an IBM Message Queueing environment (IBM MQ) then the address could be, for instance:

{
“MQ Server”: “PROD1QM”,
“QUEUE”: “INPUT.QUEUE”
}

where “MQ Server” is the name of the Queue Manager which is an IBM MQ artifact and not the name of the machine that MQ is running on. “Queue” is the endpoint where the message has been placed and received from.

Or for a Microsoft biztalk implementation (an ESB)

{
“Server”: “biztalk1”,
“Orchestration”: “MainFlow”,
“Pipeline”: “MainPipeline”,
“Port”: “HTTPPort80”,
}

Where server, in much the same way as IBM MQ, is the Microsoft biztalk artifact and not the machine name where biztalk is running. Orchestration, is the name of the core process that combines a number of pipelines. Pipelines are pieces of logic that manipulate a message e.g. mapping fields, adding to the data etc. Port is the outbound port where this event is being sent from i.e. the state of the message is being registered at the end of the flow after all the manipulation of the message has been completed.

Addressing information for one ESB Platform, could have one format and addressing information for another ESB Platform could have a different format. To give a specific example, one ESB platform by IBM Corporation is part of the IBM Sterling Software product family and is called B2Bi and has the following format for addressing information:

{
“ProcessName”: “CUST_INB_ORDERS_PROCESS”, “EventType”:
“Workflow.WFEvent.ServiceEnded.1”, “Node”: “VM3IEVI-R5”
}

Another ESB platform by IBM Corporation, is called IBM Application Connect Enterprise (aka IBM Message Broker) and has the following address information format:

{
“IntNode”: “The Integration Node e.g. Node1”,
“IntSvr”: “The Integration Server which is hosted in the IntNode e.g. Server1”,
“Appl”: “The Application e.g. Application1”,
“MsgFlow”: “The Flow Name e.g. my first flow”, “NodeLbl”: “The Flow Node eg.
MQ Input”,
“EvtSrcAddr”: “The source of the event on the Node e.g. MQ Input.terminal.out”,
“EvtName”: “The name the user gave the event e.g. My favourite event”,
}

Event data coming from the system of record platform 13, where this is a database, has much less event information, but could specify, for example, the relevant database instance and the table name within that database instance.

The addressing information can be represented in the JSON (JavaScript Object Notation) format, which is a standard text based format for representing structured data based on JavaScript object syntax. This JSON representation of the addressing information can be reformatted, once the relevant attributes are taken/derived from the system events.

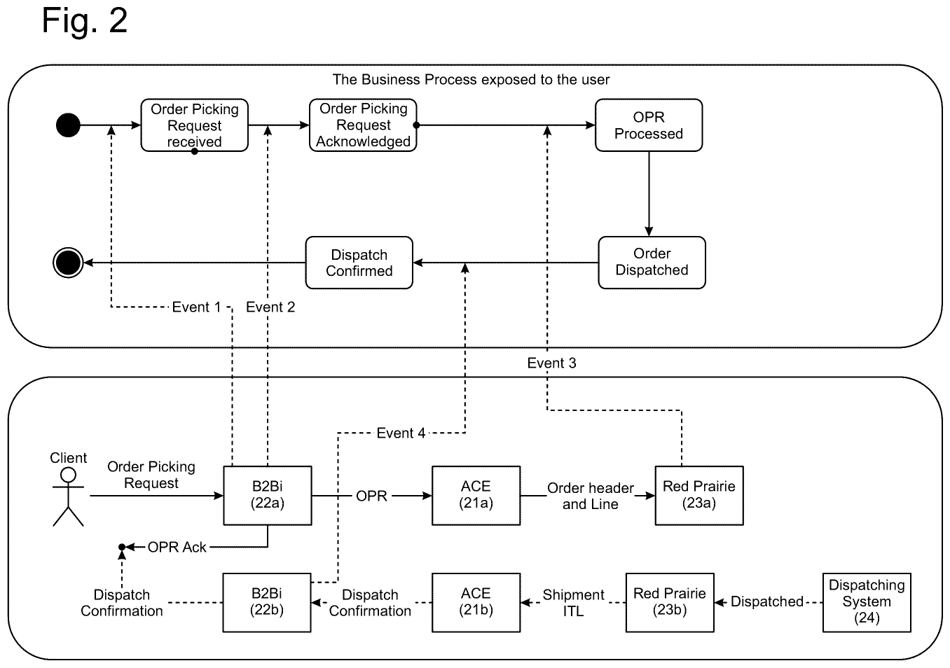

According to the teachings of the present disclosure, an Event Address Data to Status Indicator Mapping Module 14 is provided, as part of a business process monitoring server (or tool) 20 (to be described below in conjunction with FIG. 2). The Event Address Data to Status Indicator Mapping Module 14 receives the address data, mentioned above, for each event, from each of the platforms (11, 12, 13), and maps the event address data to a specific status indicator for the business method being implemented by the data processing system made up of the platforms 11, 12, 13.

For example, when specific event address data is received at the Mapping Module 14, then the Mapping Module 14 maps this specific event address data to a status indicator of Received for the business process, meaning that, when this event address data is received from the platforms 11, 12, 13, this means that a purchase order has been received by the enterprise, as part of the business process.

When other event address data is received at the Mapping Module 14, then the Mapping Module 14 maps this other event address data to a different status indicator, of Acknowledged for the business process, meaning that, when this other specific event address data is received from the platforms 11, 12, 13, then this means that a purchase order has not only been Received but has also been Acknowledged as received.

When still further event address data is received at the Mapping Module 14, then the Mapping Module 14 maps this still further event address data to a different status indicator, of Shipped, for the business process, meaning that not only has the purchase order been Received and Acknowledged, but still further, the relevant goods that were the subject of the purchase order has now been Shipped by the enterprise (to the customer). For example, this still further event address data could include events from the System of Record platform 13, as well as from any of the other platforms 11, 12.

FIG. 2 is a block diagram showing how underlying system events can be translated into business events.

The top half of the diagram in FIG. 2 labelled “The business process exposed to the user” represents a simple state diagram showing how the process moves through the stages of the process, starting with the stage of “Order Picking Request (OPR) received”, moving to “OPR acknowledged” to “OPR processed”-> “Order dispatched”-> “Dispatch confirmed”.

These business state changes (or “stages of the business process” as referred to herein) are changed by events from the plurality of platforms (or systems shown) in the bottom half of FIG. 2, e.g. Event 1 from the “B2Bi” platform/system moves the business state into “Order Picking Request Received”; Event 2 moves the process to “Order Picking Request Acknowledged”. Other platforms/systems also included in FIG. 2's bottom half diagram include two IBM App Connect Enterprise (ACE) platforms 21a/21b, two B2Bi platforms 22a/22b, two Red Prairie platforms (warehouse management systems) 23a/23b, and a Dispatching System platform 24, according to the exemplary implementation shown.

Returning to FIG. 1, in one example implementation, the Mapping Module 14 is configured in advance, by storing, in a mapping table, the event address data which is known to correspond to a particular status indicator of the business process. This often includes a combination of event address data corresponding to events from a plurality of the platforms 11, 12, 13. The mapping table is therefore populated manually by a person with knowledge of the modules 11, 12, 13 as well as knowledge of which events from such modules correspond to which status indicators of the business process. This prior population of the mapping table occurs during a modelling phase, where a model for future use, is developed, whereby the business process monitoring tool is used to configure/set-up the mapping table, manually. The modelling phase occurs prior to a runtime phase when the modules 11, 12, 13 are actually running and processing the corresponding business transaction and generating corresponding events.

As a variation of the above example implementation, a further example implementation of the disclosed technology can help to reduce the time and complexity involved in populating the mapping table, and is based on the idea that although events can come from multiple locations in one platform, the business process monitoring tool's model contains regular expressions which capture multiple address locations. For instance, where a particular platform (11, 12, 13) is the IBM App Connect platform, the address of an IBM App Connect event at runtime has the following potential address data:

Node, which can contain multiple Application Servers (although a node is not strictly a part of the addressing mechanism, it is included here and stored in the mapping table as it is useful for debugging purposes and will be referred to below in the components of the address data)

Application Server, which can contain multiple applications (Application servers can be contained in a node or can be standalone; servers host applications).

Application, which can contain multiple flows (an application is deployed to a server, an application contains artefacts, such as flow artefacts).

Flow, which can contain multiple flow nodes (a flow can be standalone or contained in an application; a flow contains flow nodes).

Flow node, which can contain event source addresses (flow nodes are the base units that constitute a flow; a flow Is made up of connected flow nodes; the key concepts are input/output nodes and the worker nodes in-between which can be of many different types, such as MQ nodes, file nodes, or compute nodes)

Event Source Address, this address is created by IBM's App Connect Enterprise (ACE) and represents the location on the node where the event has been emitted from e.g. HTTP Input.transaction.Start signifies that the event was created when a transaction has been started.

Event Name, this is a name that represents the ACE monitoring event itself. A flow node can emit events from several places in it e.g. at the beginning of it or perhaps when it errors.

The name is meant to be human-readable but defaults to the type of the node and the place where the event occurred e.g. HTTP Input. TransactionStart signifies that the node is the “HTTP Input” and the event is a transaction starting. This name could have been set to anything that made sense to the receiver of the event e.g. “The HTTP transaction has started”

At modelling time, the business process monitoring tool does not require the complete address that is expected to be output at runtime by the event system. Instead, the model can be created using regular expressions (such as “*”) which greatly simplify the modelling experience. For example: the following address could be used:

Node=* ApplicationServer=* Application=”*”
flow=”My Lovely Flow”
flow node=*
node event address=*

This address enables the business process monitoring tool to correlate any events that it receives from the flow “My Lovely Flow” without knowing, in advance, which node, application server or application the flow is finally deployed to at runtime.

This enables, for instance, the same defined process to be used when receiving events from multiple environments without altering the process itself. For instance-a development, test or production environment-all hosted on separate machines which would output events with different event attributes.

For example: If the Application Connect Enterprise address consists of . . .

Node=* ApplicationServer=* Application=”*”
flow=”My Lovely Flow” ”
“

and further let us also assume that within the test environment the application “My Lovely Flow” is deployed to the node “MyTestNode” and in production “MyProductionNode”.

Not requiring the node name and any other runtime specific address data within the business process model allows the business process monitoring tool to deploy the same monitoring model to separate environments with no changes to the business process model.

To simplify the definition of the model even further, in another example implementation, instead of being populated in advance using a pre-runtime modelling phase, in order to simplify the population of the mapping table even more, the business process monitoring tool can use the concept of automated business process creation using address locations. This is a method whereby the business process monitoring tool receives events from configured emitters (or “event handlers” as they could also be known) deployed to a runtime environment. When the event is received the business process monitoring tool checks to see if the event address has been seen before. If it hasn't, then it adds it to a list of known emitter locations.

During the creation of the business process the user can simply pick a currently running emitter location (displayed to them) rather than having to fill out the address location manually during a modelling phase prior to runtime.

This means that the user can have 100% certainty that the business process address is correct and this also speeds up the time to create business processes.

In this latter example implementation, attention is now turned to how the user interacts with the business process monitoring tool, specifically, how the user creates this environment. The goal here is that the business user should be able to ignore all the complex technology, and just be able to state, for example, that a particular invoice has been received, has been acknowledged and has been shipped.

In this latter example implementation, this is accomplished by deploying an event handler onto the run time platforms (as was mentioned just above) and use it to receive events (stream events) into a database associated with the business process monitoring tool. The user can then go through the unique event data that has been collected and use a drag and drop tool to drag and drop each one into different categories/status indicators for the business process. For example, with the actual data stored, if the user knows that the occurrence of specific data turns into an Acknowledge label, this data can be dragged and dropped into a repository associated with the Acknowledge label for the business process. Similarly, other event data from the live stream can be dragged and dropped into Shipped.

Once the mapping table has been populated by one of the above methods, the Mapping Module 14, according to an example implementation, operates as follows.

The Mapping Module 14 receives real-time events (including address information for each event) from the plurality of platforms. It recognises the type of event from fields in the event (e.g. Format-ACE; Version=1.1). Once the type of event has been recognised the address of the event is checked for in a table called the Specific Address table. If an address in the address table has a regular expression (e.g, “*”) in it then the regular expression is effectively ignored as being part of the address matching process e.g.

Database: (the below are four example entries in the Specific Address Table or database DB)

| | |
|---|---|
| Address 1: Node=”*”;ApplicationServer=”AppSvr1”; | FlowNode=”Node1”; |
| MessageFlow=”Flow1” | |
| Address 2: Node=”Node1”; ApplicationServer=”AppSvr1”; | FlowNode |
| =”Node3”; MessageFlow=“Flow1” | |
| Address 3: Node=”*”;ApplicationServer=”AppSvr2”; | FlowNode =”Node1” ; |
| MessageFlow=“Flow1” | |
| Address 4: Node=”Node1*”; ApplicationServer=”AppSvr2”; | FlowNode |
| =”Node4” ; MessageFlow=“Flow1” | |

Incoming event (this is an incoming event, just received in real time from a platform, and the address of the incoming event is to be matched with entries from the Specific Address Table):

CusID=”23”;PO=”1234”; Node=”Node1”; ApplicationServer=”AppSvr1”;
FlowNode=”Node1”;

The event consists of a unique feature about the specific document being processed—in this case a purchase order process is being discussed and the Purchase Order number is included in the event data (PO=“1234”) and the customer ID (CusID=“23”) as well as the address of the event (Node=“Node1”; ApplicationServer=“AppSvr1”; FlowNode=“Node1”)

In this case a matching engine will use standard matching libraries to compare each element of the address of the incoming event against each element of each of the addresses in the Specific Address Table, in-turn. However, it understands that addresses have an address element hierarchy and will take that into account when matching. This means that addressing is done against the parent node first e.g. “Node” is the parent of all ACE addresses and is matched first.
1) Node matching is done first: Address 1 and 3 both allow any Node to be matched to them (Node=*) and is added to the list of possible matches for this event and goes forward to the next matching round. Address 4 has a partial regular expression for its node (Node=“Node1*”) and is included in the next matching round. Address 2 is a direct match and is also included in the next matching round.
2) The next matching round is then run for the child of the parent address node—that child node being the “Application Server” address element. In this case, of the 4 possible matches only Address 1 and 2 are possible matches for the incoming event address of “ApplicationServer=AppSvr1”. Therefore Address 1 and 2 move forward to the next matching round.
3) In this example, the remaining part of the address of the incoming event is Flow Node=“Node 1”, and so, of Address 1 and 2 (which have made it through so far in the matching process) only Address 1 in the Specific Address table matches the incoming event address, and so the matching process results in only Address 1 being output from the matching process. Accordingly, the status indicator label (e.g., “shipped”) which is stored in the mapping module 14 alongside Address 1 is output from the mapping module 14 in response to receipt of the example incoming event above.
4) It is noted that, in this particular case, the incoming event did not contain the details of the whole address (“Message Flow” was omitted). In this case any data omitted from the address of the event to be matched is effectively removing itself from the matching process as if it were stating that it was coming from “Message Flow=*

The event address data from each platform, that is sent to the Mapping Module 14, can be thought of as multi-platform event location addresses, because the event data provides, to a business process monitoring tool address (location) information for events from each of the plurality of platforms.

Each of the platforms 11, 12, 13, in the example implementation, has an adapter, located adjacent each platform 11, 12, 13, and inter-coupled with the respective platform 11, 12, 13 so that the adapter can receive the event address data (event location address) occurring within the respective platform 11, 12, 13 and pass on the event address data, along with the unique identifying element of the document instance being processed (e.g. customer ID and purchase order number) to the Mapping Module 14. These adapters are, in one example implementation of the present disclosure, a part of a business process monitoring tool (20, below) for monitoring the status of a business process which is currently running in a data processing system managed by an enterprise.

The business process monitoring tool which includes the Mapping Module 14 performs its key function of tracking documents through a system by using a combination of the event address, correlated with the unique information about that document e.g. the Customer ID and the purchase order ID.

When an event is received that has been emitted from the first stage in a defined business process; this event is deemed to be starting the tracking of an “instance” of the business process-nominally, one business process instance per unique document. The data in the event that contains the unique element of the document that is being processed acts as correlation data (e.g. purchase order number and customer number). When later events from other waypoints (to be described below) in the business process are received; it is the correlation data that is used to track an individual document through the business process.

As previously described, the business process monitoring tool allows for the monitoring of a business process using event address data correlation across multiple platforms. A business process has been described above as having the concept of “stages” that an individual transaction being processed moves through e.g. the purchase order business process may define the stages for a transaction as: Received; Acknowledged; Processed; Delivered/Shipped; Invoiced.

States/stages are aimed squarely at a business user's perspective on the transaction. However, inevitably, there may be problems with the underlying platforms when processing the transaction e.g. badly formatted messages may exist. In order to allow operations focused users (ops users) to gain a better understanding of such technical problems, the business process monitoring tool, in one example implementation, introduces the concept of “waypoints”. These are additional monitoring points that do not change the state of the business process (these monitoring points for example do not change the state of the business process from Received to Acknowledged) and the data is only exposed to the operations teams (ops users) and not the business users. The business users are only interested in determining which stage/state the business process has achieved, and would not likely understand any further detail, that such waypoints would provide.

For instance:
1. Message passing through waypoint 1 (for example, in the API Management platform 11) may cause the transaction to be started and move to the “Received” state.
2. Message passing through waypoint 2 (for example, in the ESB platform 12) may not cause a state change, however, the operations team may wish to see that the message has passed through this system for error handling purposes.
3. Message passing through waypoint 3 (the system of record platform 13) causes the transaction to move to the Acknowledged state.

In this example the fact that the message had passed through the ESB platform (waypoint 2) would not be exposed to the business user. But this information is made available to the operations team.

The distinction between a monitoring point where the data is to be exposed to a business user or a monitoring point where the data is exposed to an operations user allows both teams to look at the same user interface (“single pane of glass”) but expose only the necessary information to the required team. This combines the operations (or “ops” function and the business monitoring tool into one.

Accordingly, in an example process, in order to get to a Received state, an event happens in a particular platform, and in order to get to an Acknowledged state, another event happens in another platform. For example, the ESB platform 12 is still emitting/streaming out events but many of these events do not change the state of the business process-they may just transform the data, but there may be no impact on the business process.

For example, taking the business user's perspective, a customer is on the telephone asking, “where is my invoice?” and wants an answer in real time. The business user can see the words “Received” etc as the state of the document being processed, but the business user doesn't know what may have happened in the series of platforms 11, 12, 13, the business user does not have the authority to view any further detail other than the stages of the business process. In this example, the problem may have occurred in the API Manager platform 11, the ESB platform 12 etc, but the order never got to the Shipped stage, so the business user is not able to answer the customer's question in real time (“where is my invoice?”).

According to this further enhancement of the disclosed business process management tool, the business person contacts the operations (or “ops”) team user (technical user), and informs the ops user that, for a particular invoice, the business user can see that the transaction has made its way through some states/stages but has not made it all the way through to completion (of the invoice being sent out to the customer).

The ops user, has knowledge of the underlying series of platforms 11, 12, 13, and is better placed than the business user to try to determine the cause of the problem with the transaction, so in that case, the business user can provide a hyperlink of the page on the tool's graphical user interface, that the business user could see, to the ops user, and the ops user can go to exactly the same webpage on the graphical user interface, and because the ops user has different authorities set up, the ops user can see that a Receive state means there's an event there, and can see the Acknowledge, and other events, and the ops user also has visibility regarding exactly what is happening regarding the ESB platform, even though some of these events do not have a direct association or mapping to stages of the business process, that may have an effect on the processing itself.

For example, if the underlying technical problem is that an ESB platform 12 is not online, that could mean that certain currently executing business processes, for certain key customers, are down, therefore, this visibility of such waypoints allows the enterprise to prioritise its resources such that fixing the ESB platform 12 is highest priority due to the customers that are being affected.

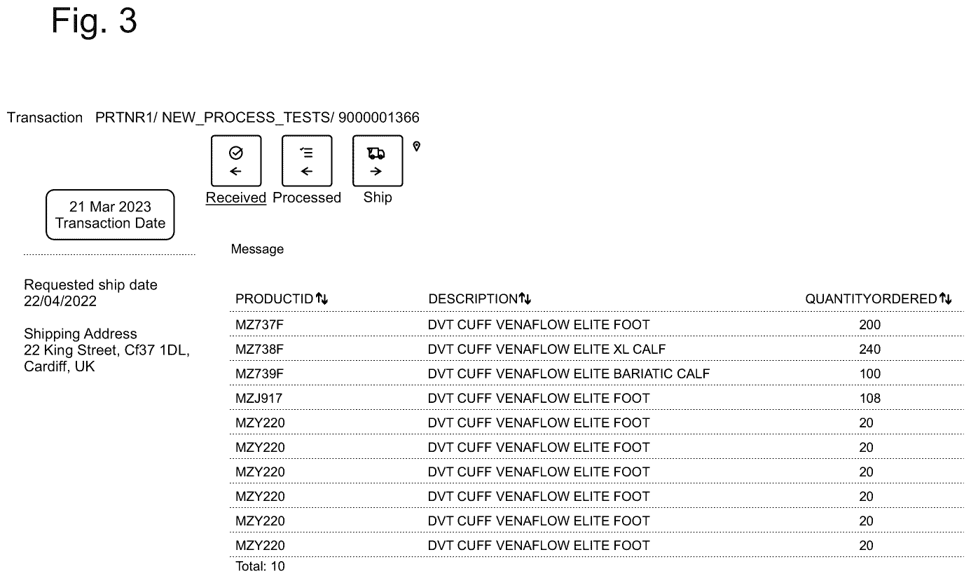

FIG. 3 shows an example of a GUI screen that the business user can see, with only the stages of the business process shown. Specifically, a transaction is shown in the user interface without the intermediate waypoints (the waypoints mentioned above which do not result in a change in the status of the business process) being shown.

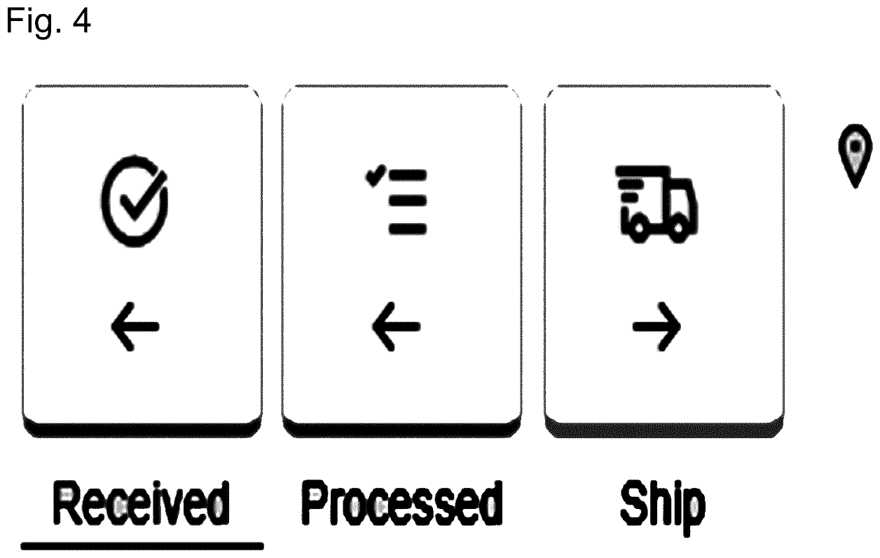

In this example the icons (shown blown up or enlarged in FIG. 4) show just the business process states i.e. Received, Processed, Shipped. This is the default view that e.g. a customer service representative might be shown as they require no knowledge of the underlying mechanisms or intermediate waypoints that the transaction might have gone through.

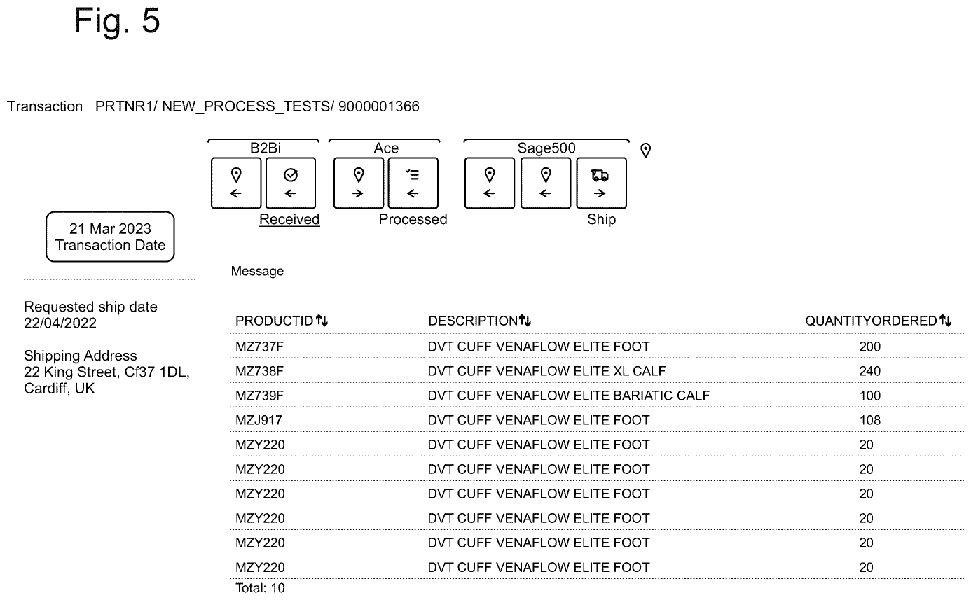

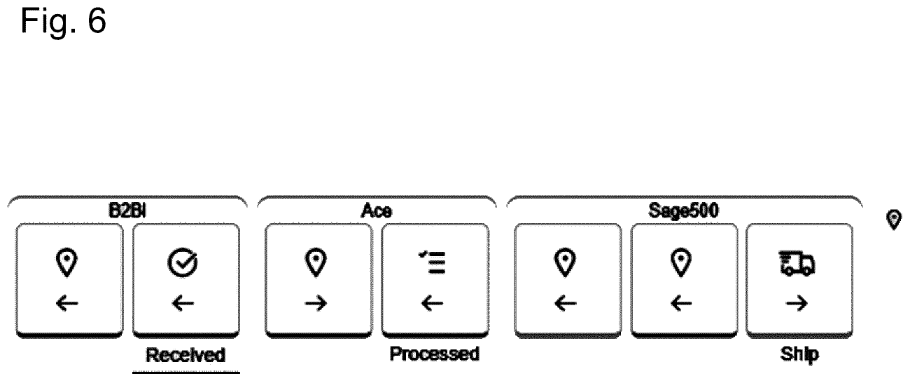

FIG. 5 shows an example of a GUI screen that the ops user can see, with the intermediate waypoints exposed. FIG. 5 shows an example of the same GUI screen as shown in FIG. 3 but when viewed with the ops user's increased authority activated, showing not only the stages of the business process but also the waypoints which are very useful to the ops user in ascertaining the nature of the technical problem that is holding up the business process. FIG. 6 below shows the expanded (blown up) view of the business process icons.

In FIG. 6, the icons have been expanded so that all the waypoints that the messages taking part in this process pass through are shown—not just the icons that the business user is interested in. For example, a waypoint is shown to the left of the waypoint with the word “Received” underneath it, and another waypoint is shown to the right of such waypoint.

Each of the waypoints to the left and right of the waypoint with the word “Received” underneath it do not have a label underneath them, and so are not of interest to the business user and are only of interest to the ops user.

A waypoint is noted with a “waypoint” or “map pin” icon whereas the waypoints that move the process from one state to another (a “stage”) usually have descriptive styled icons (e.g. a tick for received) and always have the name of the state that the process has now entered e.g. Received, indicated on the GUI screen. Indeed, the definition of a stage versus a waypoint is that a stage has the name of the state which has just been entered and a waypoint does not. Only stages are seen by the business user.

It is also noted that during this expansion to show all the waypoints of the process the underlying systems or platforms that produced the events is also shown (B2BI, ACE, Sage500 in this example)—again, providing information to the more technical user that the business orientated user will probably not want to see.

Having this systems view (or more detailed view) then allows further technical data (e.g. error messages from the underlying systems) to be represented on the screen with the systems context (e.g., B2Bi, ACE)—not just the business process context.

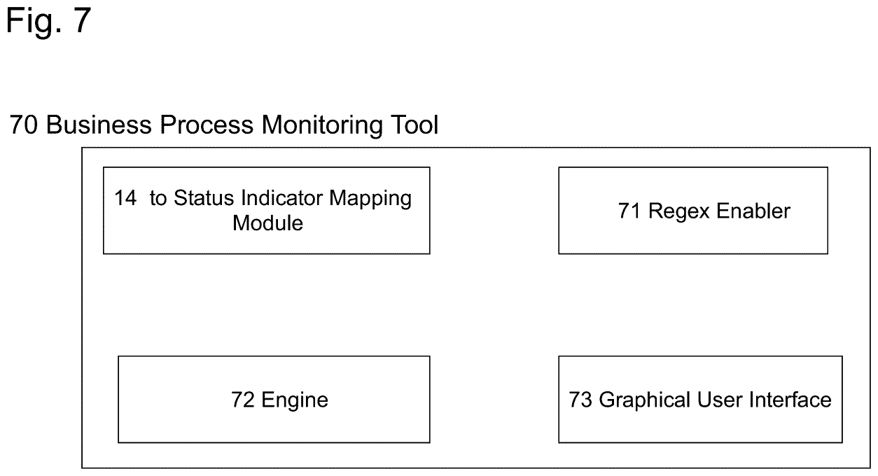

FIG. 7 is a block diagram showing an example implementation of other modules of a business process monitoring tool 70 (in addition to the adapters mentioned above), for monitoring a data processing system, according to an example implementation of the present disclosure. The Mapping Module 14, described above, is shown as part of the business process monitoring tool 70. The tool 70 also includes a regular expression (regex) enabler module 71 (which handles the regular expressions during the matching process as was described above), an engine module 72 and a graphical user interface module 73 which allows the user to perform graphics and statistics.

Specifically, the engine module 72 is provided as part of the tool 70 to perform the function of tracking individual documents through the business process (“business process instances” as they are also known), It holds, but is not limited to, the address table. This table holds information about the event addresses where data is expected to be to be received from i.e. which systems (11, 12, 13) are sending events and from where. The event addressing system is as described previously.

The module stores the definition of the business process including, but not limited to, the mapping of what system events change which business process state. Tracking the state of documents passing through the defined business processes (i.e. keeping track of the “business process instances”). It does this tracking by receiving the system events being emitted by the underling systems (11, 12, 13); it then utilises the regular expression module (71) to correlate which event corresponds to which business process instance and then changes the business process instance state accordingly.

The regular expression enabler module 71 is provided as part of the tool 70 to perform the function of analysing the system event data and identifying which business process this event correlates to.

The graphical user interface module 73 is provided as part of the tool 70 to perform the function of displaying what business processes are defined and what state the business process instances (documents) are in as they pass through the business process. In addition, it shows statistics that can be derived from the tracking of the documents.

As previously described a business process is made from a list of waypoints and stages. A waypoint is effectively an encapsulation of an address but attached to a business process. As previously described a stage is defined as a waypoint with a process state name attached thus giving the business user a context e.g. when an event is received from waypoint 1 the state of that instance of the process moves to a different stage.

A waypoint effectively describes a location in a running system where an event can be emitted from. However, the business user wishes to remain in the context of which state the business process has passed through. Therefore, a “Stage” is defined as a named waypoint as shown in an example below.
Business process 1 definition:
Waypoint 1: Name=“Order Received”; Address=“1”
Waypoint 2: Name=“ ”; Address=“2”

In the example above Waypoint 1 has been allocated a Name therefore, when an event is received from that address location, the business process instance is created and moves to the state “Order Received”.

Waypoint 2 does not have its Name attribute set and therefore does not change the state of the business process. However, the data received could be used by a non-business user (for example, a technical or ops user) to provide further information as to the progress of the document through the business process if, for example, the process fails at a later time.

In order to make this useful in the context of tracking business processes, the waypoints should be attached to a business definition in an order as shown below.

Business Process 1: Name=“Purchase Order Process”; Waypoint List=“1,2,3,4,6,8”

This overview of an example Business Process definition (The “Purchase Order Process” business process) consists of 6 waypoints (1,2,3,4,6,8) where, in this example, an event received from waypoint 1 changes the state of the business process to “Order Received”. An example implementation of this method requires that the engine module (72) receives incoming events from the underlying systems. The engine module (72) makes use of the Regular expression module (71) to work out which waypoints the event should be allocated to.

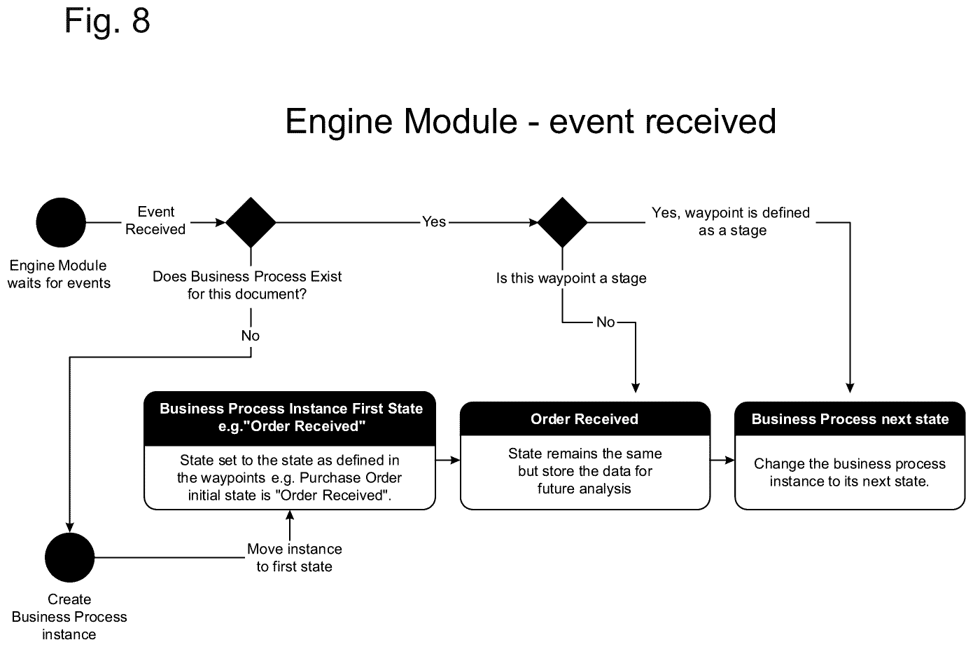

If the received event has the address of the first waypoint in a business process and this is the first time an event has been received from this address with the unique document correlation data (e.g. Purchase Order ID and Customer ID.) then a new “business process instance” is defined in the engine module. This business process instance is then used to track the progress of the business process as other events are received into the engine module. A flow of this logic is shown in FIG. 8 as “Engine Module-event received”).

It is possible for an address to have a relationship with multiple waypoints but it is unusual i.e. Address 1 could be used in both business process definition 1 and business process definition 2.

### Business Process 1 Definition:

Waypoint 1: Name=“Order Received”; Address=“1” Waypoint 2: Name=“ ”; Address=“2”

### Business Process 2 Definition:

Waypoint 1: Name=“Large Order Received”; Address=“1” Waypoint 2: Name=“ ”; Address=“12”
Business Process 1: Name=“Purchase Order Process”; Waypoint List=“1,2,3,4,6,8” Business Process 2: Name=“Large Purchase Order Process”; Waypoint List=“1,2,10,15”

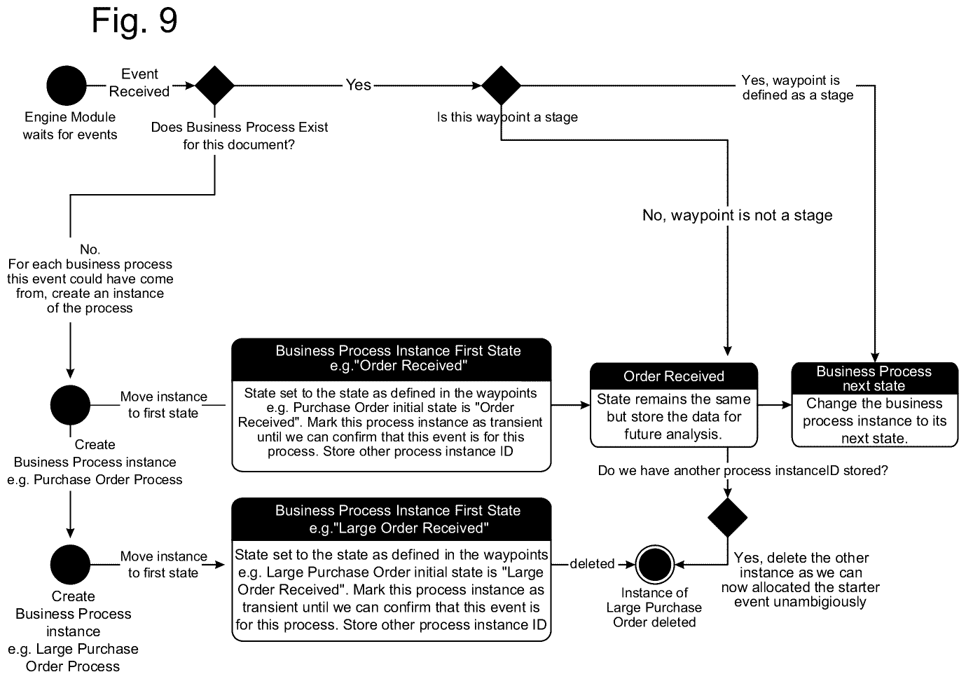

In this scenario, there is one address (address 1) which, when an event is received from it, could mean that either a “Purchase Order” has been received or a “Large Purchase Order” has been received. At runtime, the resolution of which business process has been started cannot be done until further events are received later in the business process. This logic is shown in FIG. 9 and described here.

Each document passing through the system has a unique ID. This ID is unique to each type of document being processed e.g. an invoice will have an invoice number, a Purchase Order a purchase order number etc.

Resolution of events where an event comes from an address which is taking part in two separate business processes is done by taking into account this additional, document specific, information as an augmentation to the event address. The document effectively creates a trail through the process therefore, if a system event can be aligned to one of two business processes, then the previous event locations that the document has passed through are analysed to see which business process the previous events for that document were part of. It is common for the duplicate stage to be the first stage in a business process e.g. a single FTP (file transfer protocol) address might receive multiple types of documents. In this event, the duplicity is noted and not resolved until later stages have produced events for event locations that are only assigned one business process. At this point the business process can be inferred from the first unique stage that the document passes through, and the previous duplicate entries can be resolved and the duplicitous events allocated to the, now assigned, business process and the redundant duplicate event removed from the system.

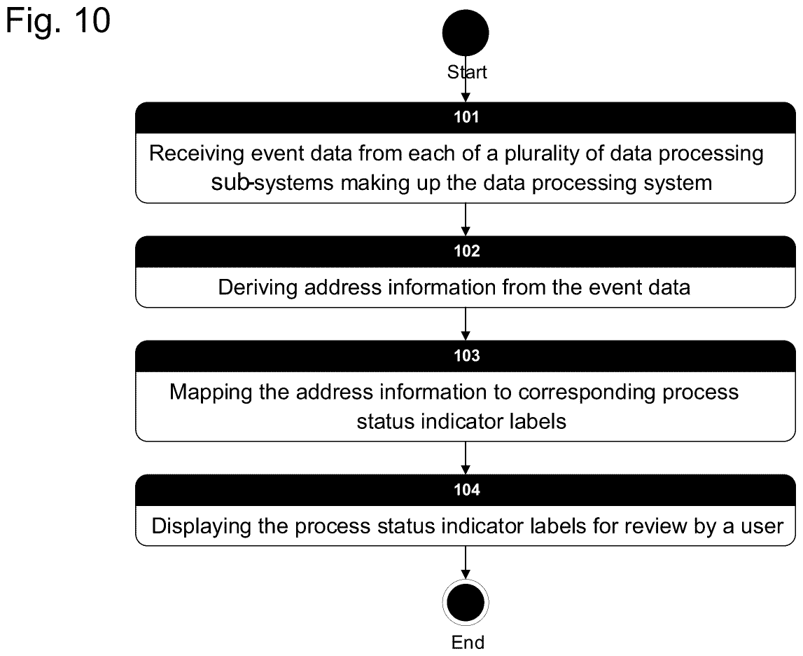

FIG. 10 is a flowchart showing functional steps which are carried out according to an example implementation of the disclosed technology.
At step 101, a method of monitoring a data processing system which is processing a transaction, begins with the step of receiving event data from each of a plurality of data processing sub-systems making up the data processing system, the event data corresponding to events taking place within the plurality of data processing sub-systems as the data processing system processes the transaction.
At step 102, the method progresses to a next step of deriving address information from the event data.
At step 103, the method progresses to a next step of mapping the address information to corresponding process status indicator labels.
At step 104, the method progresses to a step of displaying the process status indicator labels for review by a user.

What is claimed is:

1. A method of monitoring a data processing system which is processing a transaction, comprising steps of:
(a) receiving event data from each of a plurality of data processing sub-systems making up the data processing system, the event data corresponding to events taking place within the plurality of data processing sub-systems as the data processing system processes the transaction, the event data having a data structure format unique to the specific data processing sub-system from which the event data was received;
(b) deriving address information from the received event data, wherein the address information corresponds to a logical location in a corresponding sub-system where data related to a corresponding event can be perceived as having been either processed by, stored in or, having held a state in;
(c) mapping the address information to corresponding process status indicator labels; and
(d) displaying the process status indicator labels for review by a user.

2. The method of claim 1, wherein the plurality of data processing sub-systems include at least one Enterprise Service Bus data processing sub-system.

3. The method of claim 2, wherein the address information for the Enterprise Service Bus data processing sub-system includes a process name, an event type, and a node identifier.

4. The method of claim 1 wherein the mapping step is carried out using a mapping table, mapping address information to process status indicator labels, where the mapping table is pre-populated during a modelling phase, prior to a runtime phase of operation of the data processing system.

5. The method of claim 4 wherein a regular expression is used during the modelling phase to create at least one entry in the mapping table.

6. The method of claim 1 wherein the mapping step is carried out using a mapping table, mapping address information to process status indicator labels, where the mapping table is populated during a runtime phase of operation of the data processing system.

7. The method of claim 6, wherein event handlers are deployed to a runtime environment of the data processing system in order to receive event data from the data processing system while the data processing system is in the runtime phase of operation.

8. The method of claim 7, wherein event data received from the event handlers are input to a database, and the method further includes the step of displaying the event data onto a display screen, and receiving drag-and-drop input from a user whereby the user can drag specific event data and drop it into a category corresponding to a specific process status indicator label.

9. The method of claim 1, wherein the mapping step takes into account an address element hierarchy when performing the mapping.

10. The method of claim 9, wherein the taking into account of the address element hierarchy includes mapping a parent node of the address information prior to mapping a child node of the address information.

11. The method of claim 1, wherein the event data includes an identifying element of a document instance being processed by the data processing system.

12. The method of claim 11, wherein the identifying element of a document instance includes a customer number and a purchase order number.

13. The method of claim 1, wherein the processing of the transaction includes the data processing system progressing through a plurality of waypoints, where a first group of the plurality of waypoints correspond to points in the transaction which relate to a status indicator label, and a second group of the plurality of waypoints correspond to points in the transaction which do not relate to a status indicator label.

14. The method of claim 13, wherein the displaying step displays the first group of the plurality of waypoints to a first group of users, and displays the first and second groups of the plurality of waypoints to a second group of users.

15. The method of claim 14, wherein the second group of users are technical support users.

16. A system having a processor and a memory, where the memory stores instructions adapted for, when executed by the processor, carrying out a method of monitoring a data processing system which is processing a transaction, comprising steps of:
(a) receiving event data from each of a plurality of data processing sub-systems making up the data processing system, the event data corresponding to events taking place within the plurality of data processing sub-systems as the data processing system processes the transaction, the event data having a data structure format unique to the specific data processing sub-system from which the event data was received;
(b) deriving address information from the received event data, wherein the address information corresponds to a logical location in a corresponding sub-system where data related to a corresponding event can be perceived as having been either processed by, stored in or, having held a state in;
(c) mapping the address information to corresponding process status indicator labels; and
(d) displaying the process status indicator labels for review by a user.

17. A computer readable medium storing a program comprising instructions for carrying out the steps of a method, when said computer program is executed on a computer system, the method being a a method of monitoring a data processing system which is processing a transaction, comprising steps of:
(a) receiving event data from each of a plurality of data processing sub-systems making up the data processing system, the event data corresponding to events taking place within the plurality of data processing sub-systems as the data processing system processes the transaction, the event data having a data structure format unique to the specific data processing sub-system from which the event data was received;
(b) deriving address information from the received event data, wherein the address information corresponds to a logical location in a corresponding sub-system where data related to a corresponding event can be perceived as having been either processed by, stored in or, having held a state in;
(c) mapping the address information to corresponding process status indicator labels; and
(d) displaying the process status indicator labels for review by a user.
